(19) United States
(12) Patent Application Publication
(10) Pub. No.: US 2012/0056947 A1
(43) Pub. Date: Mar. 8, 2012

(54) INKJET HEAD AND METHOD OF MANUFACTURING THE SAME

(75) Inventors: Chiaki Tanuma, Tokyo (JP); Shuhei Yokoyama, Shizuoka (JP); Ryuichi Arai, Shizuoka (JP); Ryutaro Kusunoki, Shizuoka (JP)

(73) Assignee: TOSHIBA TEC KABUSHIKI KAISHA, Tokyo (JP)

(21) Appl. No.: 13/224,966

(22) Filed: Sep. 2, 2011

(30) Foreign Application Priority Data
Sep. 3, 2010 (JP) 2010-197970
Aug. 23, 2011 (JP) 2011-181219

(51) Int. Cl. B41J 2/045; B23P 11/00

(52) U.S. Cl. 347/71; 29/890.1

(57) ABSTRACT

An inkjet head including: a nozzle plate including: a nozzle configured to eject ink; a first electrode formed to surround the nozzle; a piezoelectric film provided to surround the nozzle and in contact with the first electrode; and a second electrode formed in contact with the piezoelectric film and made of a metal material forming the nozzle; and an ink supply path for supplying the ink to the nozzle.

### CROSS-REFERENCE TO RELATED APPLICATION

This application claims the benefit of the prior Japanese Patent Application No. 2010-197970 field on Sep. 3, 2010, and No. 2011-181219 field on Aug. 23, 2011, the entire contents of both of which are incorporated herein by reference.

### FIELD

Embodiments described herein relate generally to an inkjet head that ejects ink from nozzles and forms an image, and a method of manufacturing the inkjet head.

### BACKGROUND

There is known an on-demand type inkjet recording system for ejecting ink droplets from nozzles in response to an image signal and forming an image by the ink droplets on recording paper. The on-demand type inkjet recording system includes a heat generating element and a piezoelectric element. The heat generating element energizes a heat generating body provided in an ink channel to generate air bubbles in ink and eject the ink forced by the air bubbles from nozzles. The piezoelectric element ejects ink stored in an ink chamber from nozzles making use of deformation of a piezoelectric element.

The piezoelectric element is an element that converts a voltage into force. When an electric field is applied to the piezoelectric element, the piezoelectric element undergoes extension or shear deformation. As a representative piezoelectric element, lead zirconate titanate is used.

As an inkjet head that employs the piezoelectric element, a configuration including a nozzle board formed of a piezoelectric material is known. In this inkjet head, electrodes are formed on both surfaces of the piezoelectric nozzle board (formed of the piezoelectric material) to surround nozzles that eject ink. The ink enters between the nozzle board and a substrate that supports the nozzle board. The ink forms meniscuses in the nozzles and is maintained in the nozzles. When a driving waveform for oscillating the piezoelectric element is applied to the electrodes of the nozzle board, the piezoelectric element around the nozzles oscillates. The piezoelectric element oscillates to thereby cause ultrasonic oscillation in the nozzles. As a result, the ink in the meniscuses is ejected.

### DESCRIPTION OF THE DRAWINGS

FIG. 1 is a disassembled perspective view of an inkjet head according to a first embodiment;

FIG. 2 is a plan view of the inkjet head according to the first embodiment;

FIGS. 3A to 3D are diagrams for explaining a manufacturing process for the inkjet head according to the first embodiment;

FIGS. 4E to 4H are diagrams for explaining a manufacturing process for the inkjet head following the manufacturing process shown in FIGS. 3A to 3D in the first embodiment;

FIGS. 5I and 5J are diagrams for explaining a manufacturing process for the inkjet head following the manufacturing process shown in FIGS. 4E to 4H in the first embodiment;

FIG. 6 is an A-A′ sectional view of the inkjet head according to the first embodiment;

FIG. 7 is a plan view of an inkjet head according to a second embodiment; and

FIG. 8 is a plan view of an inkjet head according to a third embodiment.

### DETAILED DESCRIPTION

According to an embodiment, an inkjet head includes a nozzle plate in which a nozzle having an ejection hole for ink, an ink supply path for supplying the ink to the nozzle, a first electrode formed to surround the ejection hole of the nozzle of the nozzle plate, a piezoelectric film configured to at least partially surround the ejection hole of the nozzle of the nozzle plate and cover the first electrode, a second electrode configured to cover the piezoelectric film and made of a metal material.

Embodiments are explained below with reference to the accompanying drawings.

### First Embodiment

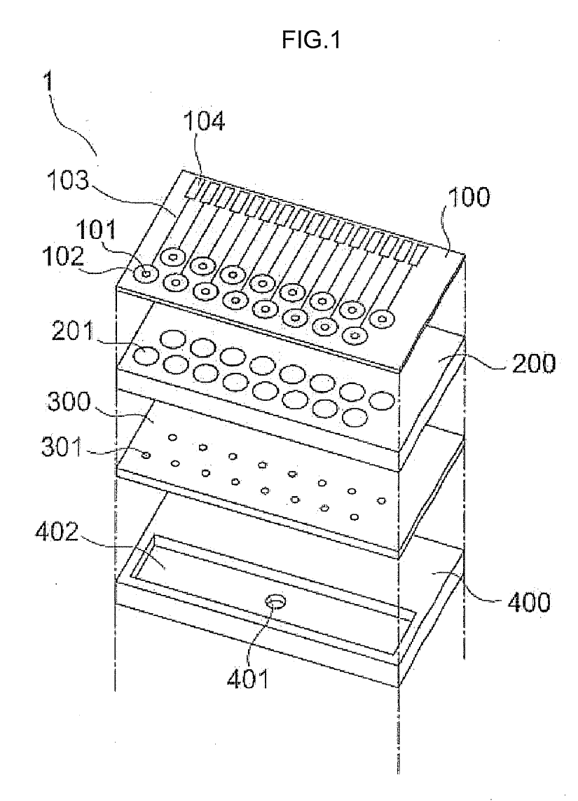

FIG. 1 is a disassembled perspective view of an inkjet head according to a first embodiment.

An inkjet head 1 shown in FIG. 1 includes a nozzle plate 100, an ink pressure chamber structure 200, a separate plate 300, and an ink supply path structure 400.

The nozzle plate 100 includes plural nozzles 101 for ink ejection (ink ejection holes) that pierce through the nozzle plate 100 in the thickness direction thereof. The ink pressure chamber structure 200 includes plural ink pressure chambers 201 corresponding to the plural nozzles 101. One ink pressure chamber 201 is connected to the nozzle 101 corresponding thereto. The separate plate 300 includes plural ink chokes 301 (openings for ink supply to the ink pressure chambers) respectively connected to the ink pressure chambers 201 formed in the ink pressure chamber structure 200.

The inkjet head 1 is configured so that individual ink pressure chambers 201 and ink chokes 301 correspond to individual plural nozzles 101. The ink pressure chambers 201 are connected to an ink supply path 402 through the ink chokes 301.

The ink pressure chambers 201 store ink prior to release for image formation. A pressure change occurs in the ink in the ink pressure chambers 201 in response to deformation of the nozzle plate 100 and as a result the ink is ejected from the inkjet head 1 through the nozzles 101. At this point, the separate plate 300 plays a role in confining pressure generated in the ink pressure chambers 201 and preventing the pressure from escaping to the ink supply path 402. In order to control pressure in this manner, the diameter of the ink chokes 301 is equal to or smaller than a quarter of the diameter of the ink pressure chambers 201.

The ink supply path 402 is provided in the ink supply path structure 400. An ink supply port 401 for supplying the ink from the outside of the inkjet head 1 is provided in the ink supply path structure 400. The ink supply path 402 surrounds all the plural ink pressure chambers 201 such that the ink can be supplied to all the ink pressure chambers 201.

The ink pressure chamber structure 200 is made of a suitable material having a suitable thickness, such as an alumina ceramic having thickness from 0.5 mm to 5 mm, for example 2 mm. The ink pressure chambers 201 have a substantially cylindrical shape with a diameter sufficient for the passage of ink therethrough, such as a diameter from 0.5 mm to 5 mm, for example 3 mm. Ejection holes of the nozzles 101 are provided at or near the centers of circles of the ink pressure chambers 201.

The separate plate 300 is made of a relatively hard material suitable for controlling pressure, such as stainless steel having thickness from 50 μm to 500 μm, for example 200 μm. The diameter of the ink chokes 301 is set to confine pressure in the ink pressure chamber structure 200, from 100 μm to 1,000 μm, for example 500 μm. The separate plate 300 can be made to facilitate suppression of shape fluctuations of the ink chokes 301 such that ink channel resistances to the respective ink pressure chambers 201 are substantially the same.

The ink supply path structure 400 is made of a suitable material having a suitable thickness, such as an alumina ceramic having a thickness from 1 mm to 10 mm, for example 4 mm. The ink supply path 402 is provided at depth to contain a predetermined amount of ink, such as from 0.5 mm to 5 mm, for example 2 mm from the surface. The ink supply port 401 is provided nearby or in substantially the center of the ink supply path 402. The ink supply path 402 is made such that ink channel resistances to the ink pressure chambers 201 are substantially the same.

The nozzle plate 100, the ink pressure chamber structure 200, the separate plate 300, and the ink supply path structure 400 can be fixed by an adhesive suitably matched for the specific materials of the nozzle plate 100, the ink pressure chamber structure 200, the separate plate 300, and the ink supply path structure 400, such as an epoxy adhesive such that the nozzles 101 and the ink pressure chambers 201 keep a predetermined positional relation.

The ink pressure chamber structure 200 and the ink supply path structure 400 can be made of alumina ceramics and the separate plate 300 can be made of stainless steel. However, the materials of the structures 200, 300, and 400 are not limited to alumina ceramics and stainless steel. It is also possible to use other materials taking into account differences between coefficients of expansion of the materials and a coefficient of expansion of the nozzle plate 100 as long as the materials do not affect the generation of ink ejection pressure. For example, as a ceramic material, zirconia, silicon carbide, and nitrides and oxides such as silicon nitride and barium titanate can also be used. As a resin material, plastic materials such as ABS (acrylonitrile butadiene styrene), polyacetal, polyamide, polycarbonate, and polyether sulfone can also be used. A metal material (various alloys) can also be used. As representative materials, there are materials such as aluminum and titanium.

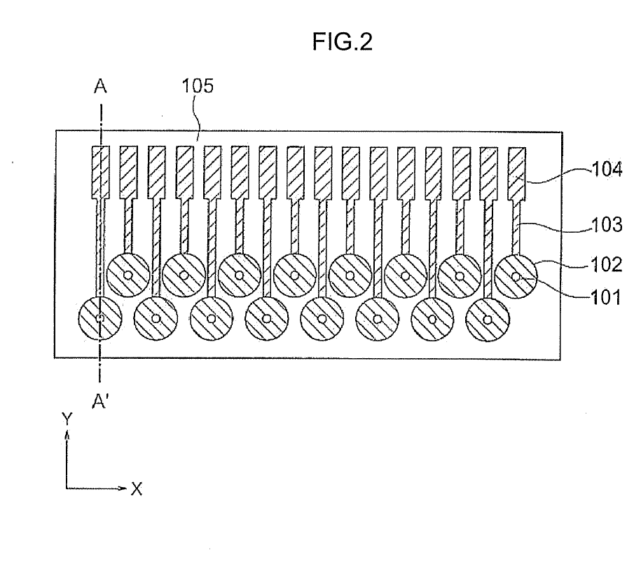

The configuration of the nozzle plate 100 is explained with reference to FIG. 2. FIG. 2 is a plan view of the nozzle plate 100 viewed from an ink ejection side.

The nozzle plate 100 includes the plural nozzles 101 configured to eject the ink and plural actuators 102 configured to generate pressure for ejecting the ink from the nozzles 101. Plural wiring electrodes 103 transmit signals for driving the actuators 102 corresponding thereto. Plural electrode terminals 104 are connected to the wiring electrodes corresponding thereto. A signal for driving the inkjet head 1 is supplied to the electrode terminals 104 from the outside of the inkjet head. Each of the actuators 102 includes electrodes (an electrode film 109 and an electroformed film 112 explained later) functioning as the other electrode. The plural nozzles 101, the plural actuators 102, the plural wiring electrodes 103 (first electrodes), the plural electrode terminals 104, and plural electrodes formed in the nozzle plate 100 are formed on a base substrate 105. The base substrate 105 is removed after the nozzle plate 100 is formed.

The plural nozzles 101 are configured to eject the ink piercing through the nozzle plate 100. The center of the circular section of one ink pressure chamber 201 and the center of the nozzle 101 corresponding thereto at least substantially coincide with each other. The ink is supplied from an individual ink pressure chamber 201 into the nozzle 101 corresponding thereto. The base substrate 105 is deformed by the operation of the actuator 102 corresponding to the nozzle 101. The ink is discharged from the nozzle 101 by a pressure change caused in the ink pressure chamber 201. All the nozzles 101 perform substantially the same or the same operation.

The plural nozzles 101 can be formed in any shape, such as a conical shape, the cross-sectional area of which decreases from the ink pressure chambers 201 side to an ink ejection side of the nozzle plate 100. In other words, the opening area on the ink pressure chambers 201 side is larger than the opening area on the ink ejection side of the nozzle plate 100. An ejection side opening of the nozzle plate 100 has a suitable diameter for ejecting ink, such as a diameter from 5 μm to 50 μm, for example 30 μm. An opening on the ink pressure chamber 201 side has a suitable diameter for collecting ink, such as a diameter from 10 μm to 100 μm, for example 50 μm.

The plural actuators 102 are formed of piezoelectric films. Each of the actuators 102 operates using the piezoelectric film and two electrodes that hold the piezoelectric film. When the piezoelectric film is formed, polarization occurs in the thickness direction of the piezoelectric film. If an electric field in a direction same as the direction of the polarization is applied to the piezoelectric film via the electrodes, the actuator 102 expands and contracts in a direction orthogonal to the electric field direction. The base substrate 105 is deformed making use of this expansion and contraction and causes a pressure change in the ink in the ink pressure chamber 201. The shape of the piezoelectric film is any shape that can surround the ejection side opening of the nozzle 101, such as circular. The piezoelectric film is typically present in a circle concentric with the ejection side opening of the nozzle 101. The diameter of the circular piezoelectric film is set to cause desired pressure changes, such as from 1 mm to 5 mm, for example 3 mm. In other words, the piezoelectric film surrounds the ejection side opening of the nozzle 101.

The plural actuators 102 can be arranged in any suitable manner, such as a zigzag (alternately) in order to arrange the nozzles 101 at high density. The plural nozzles 101 can be provided linearly in an X axis direction as shown in of FIG. 2. Two liner nozzle rows are provided in a Y axis direction. A distance between the centers of two nozzles 101 adjacent in the X axis direction depends upon the desired number of nozzles, but can be from 1 mm to 10 mm, such as 5 mm. An arrangement interval of two rows of the nozzles 101 also depends upon the desired number of nozzles, and can be from 1 mm to 10 mm, such as 3 mm in the Y axis direction. By arranging the nozzles 101 in this way, the plural long wiring electrodes 103 are formed to pass between adjacent two actuators 102.

An example of a material of the piezoelectric film of the actuator, PZT (lead zirconate titanate) can be used. Examples of other materials include PTO (PbTiO3: lead titanate), PMNT (Pb(Mg1/3Nb2/3)O3-PbTiO3), PZNT (Pb(Zn1/3Nb2/3)O3-PbTiO3), ZnO, AlN, and the like.

The piezoelectric film can be formed, for example, at substrate temperature of 350° C. by an RF magnetron sputtering method. The thickness of the piezoelectric film can be, for example, set to 3 μm. After the piezoelectric film formation, in order to give piezoelectric properties to the piezoelectric film, heat treatment can be performed, for example for three hours at 500° C. Consequently, satisfactory piezoelectric performance is able to be obtained. As other manufacturing methods for the piezoelectric film, a CVD (a chemical vapor deposition method), a sol-gel method, an AD method (an aero-sol deposition method), a hydrothermal synthesis method, and the like can also be used. The thickness of the piezoelectric film is determined according to a piezoelectric characteristic, a dielectric breakdown voltage, and the like. The thickness of the piezoelectric film is generally in a range of 0.1 μm to 10 μm.

The plural wiring electrodes 103 can be one of two electrodes connected to the piezoelectric films of the plural actuators 102. Each of the wiring electrodes 103 can be separately connected to the piezoelectric film of the actuator 102 corresponding thereto. Each of the wiring electrodes 103 acts as an individual electrode for causing the piezoelectric film to independently operate. Each of the wiring electrodes 103 includes a circular electrode section having a diameter smaller than that of the circular piezoelectric film and a wiring section connected to the electrode terminal 104 corresponding to the wiring electrode 103. The nozzle 101 corresponding to the wiring electrode 103 can be formed in the center of the circular electrode section. Therefore, a section without a wiring electrode film can be formed in a shape of a circle concentric with the nozzle 101.

The plural wiring electrodes 103 and the plural electrode terminals 104 can be formed, for example, of a Pt (platinum)/Ti (titanium) thin film. For the formation of the thin film, a sputtering method can be used. The thickness of the thin film is set to 0.5 μm, for example. Example of other electrode materials of the wiring electrodes and the electrode terminals include Ni (nickel), Cu (copper), Al (aluminum), Ti (titanium), W (tantalum), Mo (molybdenum), Au (gold), and the like. Examples of other film forming methods include vapor deposition and metal plating. Desirable thickness of the plural wiring electrodes 103 and the plural electrode terminals 104 is 0.01 μm to 1 μm.

The plural electrode terminals 104 can be connected to the actuators 102 corresponding thereto through the wiring electrodes 103. A signal for driving the actuators 102 can be supplied to the electrode terminals 104 from an external driving circuit. The wiring electrodes 103 can be wired between the electrode terminals 104 and the actuators 102. In this embodiment, wiring width is about 1 mm. An interval of the plural electrode terminals 104 can be the same as an interval in the X axis direction of the plural nozzles 101. Therefore, the width in the X axis direction of the electrode terminals 104 can be set large compared with the wiring width of the wiring electrodes 103. This facilitates connecting the external driving circuit and the plural electrode terminals 104. The electrode terminals 104 and the wiring electrodes 103 can function as individual electrodes configured to drive the actuators 102.

As the base substrate 105, a quartz substrate can be used. During electroforming, a pattern having a shape corresponding to the nozzle 101 of a photo resist can be formed in a section formed as the nozzle 101. An electroformed film can be formed in a section excluding this pattern to form the nozzle 101. When the electroforming is performed, the nozzle 101 can be formed under optimum conditions of addition of elements, current density, and temperature for reducing internal stress

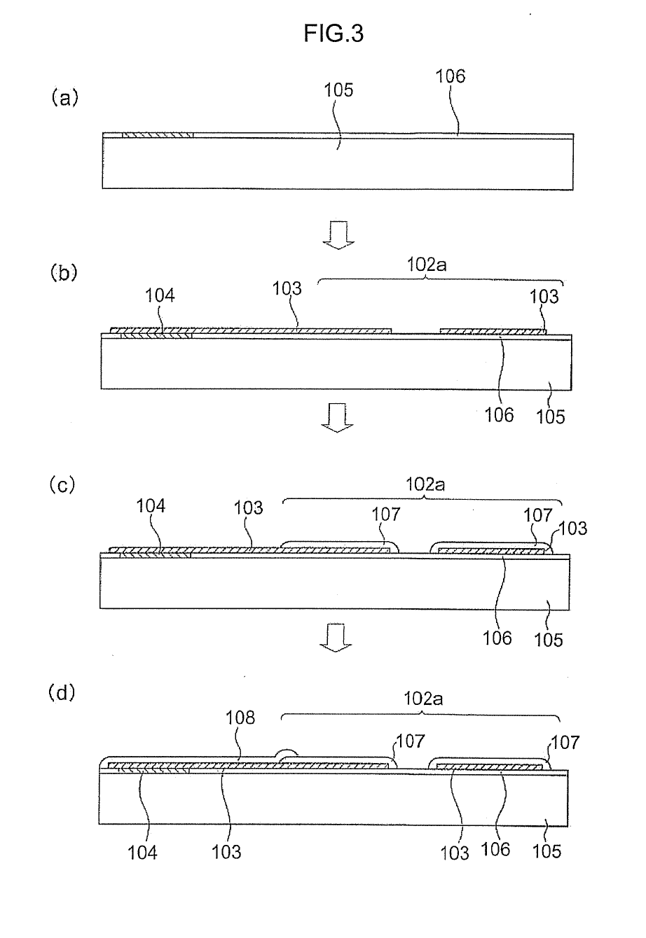

A method of manufacturing this inkjet head is explained with reference to an A-A′ section of FIG. 2 shown in FIGS. 3A to 5J. All the nozzles 101 on the base substrate 105 can be simultaneously manufactured.

FIGS. 3A to 5J are diagrams of a manufacturing process of the inkjet head. Materials forming the inkjet head are subjected to film formation by thin filming or electroforming to manufacture the inkjet head.

In FIG. 3A, a configuration in which an insulating film 106 can be formed on the quartz substrate 105 (the base substrate) is shown. In order to form the nozzle plate 100, the quartz substrate 105 subjected to mirror polishing can be used. In a process for forming the nozzle plate 100, since heating, formation of a thin film, metal plating, immersion in electroforming fluid, and the like are repeated, quartz having heat resistance can be used. The quartz substrate 105 can be a smoothed quartz substrate having thickness of 3 mm. Instead of the quartz substrate 105, a substrate of ceramics, silicon, or various kinds of metal having heat resistance can also be used.

After an ink pressure chamber structure and an ink supply path structure are attached to the quartz substrate 105, the quartz substrate 105 can be removed by grinding or polishing.

As the insulating film 106, an SiO2 film (silicon oxide) formed by the CVD method can be used. A film is formed over the entire surface of the quartz substrate 105 at thickness of 0.5 μm for example. After the film formation, the SiO2 film in a forming section of the electrode terminal 104 can be etched and removed.

The thickness of the insulating film 106 is desirably in a range of 0.1 μm to 1 μm. Instead of SiO2, SiN (silicon nitride), Al2O3 (aluminum oxide), HfO2 (hafnium oxide), or DLC (Diamond Like Carbon) can also be used. A material of the insulating film 106 can be selected taking into account insulating properties, a coefficient of thermal expansion, smoothness, wettability, and the like.

In FIG. 3B, an electrode film (the wiring electrode 103 and the electrode terminal 104) formed on the insulating film 106 is shown. A material of the electrode film can be Pt and/or Ti. Films of Ti and Pt can be formed in order using the sputtering method. Film thickness equivalent to the electrode terminal 104 can be set to 0.5 μm. Pt film thickness on the electrode terminal 104 and the insulating film 106 can be set to 0.05 μm. After the electrode film is formed, the electrode film is patterned into a shape suitable for the wiring electrode 103, the electrode terminal 104, and the actuator 102. The wiring electrode 103, the electrode terminal 104, and an actuator wiring electrode 102a can be formed. The patterning can be performed by forming an etching mask on the electrode film and removing electrode materials excluding the etching mask with etching. The etching mask can be formed by, after applying a photo resist on the electrode film, performing a pre-bake, exposing the electrode film using a mask on which a desired pattern is formed, and performing a post-bake through a development process.

A section of the actuator wiring electrode 102a equivalent to a piezoelectric film 107 can be a circular pattern having an outer diameter of 3 mm. Since the nozzle 101 is formed at or near the center of the circular actuator wiring electrode 102a, a section having a diameter of 0.63 mm, for example, without the actuator wiring electrode 102a can be formed as a concentric circle from the center of the circular actuator wiring electrode 102a.

In FIG. 3C, the piezoelectric film 107 formed on the actuator wiring electrode 102a is shown. The electrode terminal 104, the wiring electrode 103, and the actuator wiring electrode 102a can be formed by patterning an electrode film. The insulating film 106 can be exposed in sections excluding the wiring electrode 103, the electrode terminal 104, and the actuator wiring electrode 102a. In order to form the piezoelectric film 107 only on the actuator wiring electrode 102a, first, the piezoelectric film 107 can be formed on the electrode terminal 104, the wiring electrode 103, the actuator wiring electrode 102a, and the insulating film 106. PZT can be used for the piezoelectric film 107. The piezoelectric film 107 having thickness of 3 μm can be formed by the sputtering method at substrate temperature of 350° C., for example. In order to give piezoelectric properties to a PZT thin film, heat treatment can be performed for three hours at 500° C. When the PZT thin film is formed, polarization typically occurs along a film thickness direction from the wiring electrode 103.

Patterning of the piezoelectric film 107 can be performed by etching. A photo resist can be applied on the piezoelectric film 107. Subsequently, a pre-bake can be performed. Exposure can be performed using a mask on which a desired pattern can be formed. A post-bake can be performed through development and fixing processes to form an etching mask of the photo resist. Etching can be performed using this etching mask to obtain the piezoelectric film 107 having a desired shape.

A pattern of the piezoelectric film 107 can be a circular shape having an outer diameter of 3 mm for example. Since the nozzle 101 can be formed in the center of the circular pattern, a section having a diameter of 0.23 mm without a piezoelectric film can be formed in the center of the circular piezoelectric film 107. The insulating film 106 can be exposed in the section having the diameter of 0.23 mm, for example, without the piezoelectric film. Since the diameter of the section without the circular piezoelectric film can be 0.23 mm and the diameter of the section without the circular actuator wiring electrode 102a can be 0.63 mm, the piezoelectric film 107 can be formed to cover the actuator wiring electrode 102a. Since the piezoelectric film 107 covers the actuator wiring electrode 102a, insulating properties between the wiring electrode 103 and another electrode for applying a voltage to the piezoelectric film 107 can be secured. In other words, the wiring electrode 103 for driving the actuator 102 and the electrode can be insulated by the piezoelectric film 107.

In FIG. 3D, the electrode terminal 104 and an insulating film 108 on the wiring electrode 103 connected to the electrode terminal 104 are shown. In order to keep the insulation between the wiring electrode 103 and the electrode, the insulating film 108 can be formed on the surfaces of the wiring electrode 103 and the electrode terminal 104 on which the piezoelectric film 107 is not formed. The thickness of the insulating film 108 can be set to 0.2 μm and a material of the insulating film 108 can be SiO2. For the formation of the insulating film 108, the CVD method that can realize satisfactory insulating properties with low-temperature film formation can be used. Since the insulating film 108 has to be formed only on the surfaces of the electrodes, patterning can be performed. After a resist is applied, a pre-bake can be performed, exposure can be performed using a mask of a desired pattern, and a post-bake can be performed through development and fixing processes to form an etching mask. Etching can be performed using this etching mask to obtain a desired insulating film 108. The insulating film 108 can be patterned to cover a part of the piezoelectric film 107. An amount of covering of the piezoelectric film 107 by the insulating film 108 can be set to a degree for not hindering a deformation amount of the piezoelectric film 107.

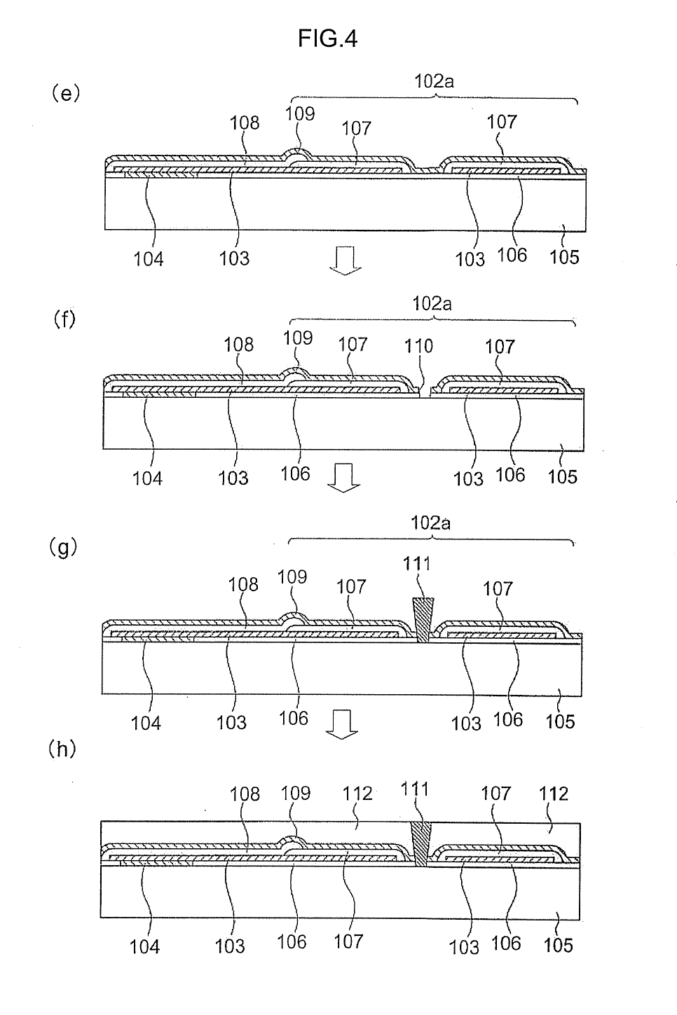

In FIG. 4E, formation of the electrode film 109 functioning as a base for forming the electrode of the actuator 102 is shown. The electrode film 109 can be made of Pt and has thickness of 0.5 μm, for example. The electrode film 109 can be formed by the sputtering method.

Examples of other film formation materials for the electrode film 109 include one or more of Cu, Al, Ag, Ti, W, Mo, Pt, and Au. Examples of other formation methods for the electrode film 109 include vacuum deposition, metal plating, and the like. The thickness of the electrode film 109 can be desirably in a range of 0.01 μm to 1 μm. The electrode film 109 covers at least the piezoelectric film 107. The electrode film 109 covers the insulating film 108 as well.

In FIG. 4F, a removing section 110 where the electrode film 109 and the insulating film 106 in a forming section of the nozzle 101 are removed is shown. The section corresponding to the nozzle 101 is at or near the center of the actuator wiring electrode 102a and can be a two-layer film formed by laminating the insulating film 106 and the electrode film 109 on the quartz substrate 105. A photo resist film can be formed on the electrode film 109, exposed using a photomask that can form an ejection hole (having a diameter of 30 μm) of the nozzle 101 in the center of the piezoelectric film 107, and developed to form an etching mask. Etching of the electrode film 109 and the insulating film 106 can be performed using this mask to form the removing section 110.

In FIG. 4G, a pattern 111 of the photo resist for forming the nozzle 101 is shown. The pattern 111 forming the shape of the nozzle 101 can be formed by the photo resist in the removing section 110 of the electrode film 109 and the insulating film 106. The ejection hole of the nozzle 101 can be formed by the pattern 111 of the photo resist. The photo resist pattern 111 has a circular truncated cone shape, for example. The circular truncated cone of the resist pattern 111 can be formed such that a diameter on the quartz substrate 105 side is 30 μm, height is 50 μm, and a diameter on the opposite side of the quartz substrate 105 is about 50 μm, for example. Therefore, the resist pattern 111 can be formed to have a diameter that is small on the quartz substrate 105 side and increases further away from the quartz substrate 105 side. A maximum diameter can be set to about 50 μm.

Fabrication of the circular truncated cone of the resist pattern 111 is explained. The photo resist can be applied at thickness of 50 μM on the electrode film 109 and the removing section 110 formed as shown in FIG. 4F. An Al film can be formed at thickness of 1 μm on a photo resist film by the sputtering method. The Al film can be fabricated into a circular pattern having a diameter of 50 μm, which is the maximum diameter of the nozzle 101, using the photo resist and the etching method. The Al pattern can be arranged such that the center of the circular pattern of Al and the center of the nozzle 101 form concentric circles. The photo resist formed on the exposure film 109 and the removing section 110 can be exposed using the circular Al pattern as an exposure mask for an ultraviolet ray. The ultraviolet ray can be irradiated on the photo resist and transmitted through the photo resist. Transmitted light of the ultraviolet ray is slightly diffracted by the circular Al pattern. The ultraviolet ray forms an exposure pattern that inclines in the photo resist. Therefore, when the photo resist is developed, the resist pattern 111 is formed.

In FIG. 4H, an electroformed film 112 deposited on the electrode film 109 is shown. After the resist pattern 111 is formed, the electroformed film 112 can be formed by an electroforming method. The electroformed film 112 can be made of an Ni material. The thickness of the electroformed film 112 can be set to 50 μm.

The electroformed film 112 can be formed by immersing the fabricated product shown in FIG. 4G in an electroforming bath and depositing metal ions (Ni ions in this embodiment), which are electrolyzed using the electrode film 109, on the electrode film 109. When the electroformed film 112 is formed, the film formation can be performed under conditions in which internal stress generated in the electroformed film 112 is as small as possible.

In selection of a material of the electroformed film 112, a Young's modulus of the material is substantially different from those of the materials of the insulating film 106 and the wiring electrode 103. In other words, the material of the electroformed film 112 is desirably a material, a Young's modulus of which is substantially different from a Young's modulus of the insulating film 106 and a Young's modulus of the wiring electrode 103. A deformation amount of a plate shape is affected by a Young's modulus and plate thickness of a plate material. Even if the same force is applied, deformation is larger as the Young's modulus is smaller and the plate thickness is smaller.

In this embodiment, whereas a Young's modulus of an Ni film (having thickness of 50 μm) of the electroformed film 112 is 199 GPa, a Young's modulus of an SiO2 film of the insulating film 106 is 80.6 GPa. The wiring electrode 103 can be a laminated film of Pt=0.05 μm and Ti=0.45 μm. Since a Young's modulus of Ti occupying 90% of film thickness is 116 GPa, there is a difference equal to or larger than 80 GPa. A reason for this is explained below.

The inkjet head according to this embodiment has a structure in which the actuator 102 is held between a laminated film of the electrode film 109 and the electroformed film 112 and a laminated film of the insulating film 106 and the wiring electrode 103. If an electric field is applied to the actuator 102 and the actuator 102 expands in a direction orthogonal to an electric field direction, force for deforming the laminated film of the electrode film 109 and the electroformed film 112 to the ink pressure chamber 201 side in a concave shape is applied to the laminated film. Conversely, force for deforming the laminated film of the insulating film 106 and the wiring electrode 103 to the ink pressure chamber 201 side in a convex shape is applied to the laminated film. If the actuator 102 contracts in the direction orthogonal to the electric field direction, force for deforming the laminated film of the electrode film 109 and the electroformed film 112 to the ink pressure chamber 201 side in a convex shape is applied to the laminated film and force for deforming the laminated film of the insulating film 106 and the wiring electrode 103 to the ink pressure chamber 201 side in a concave shape is applied to the laminated film.

In other words, if the actuator 102 expands and contracts in the direction orthogonal to the electric field direction, forces for deforming the laminated film of the electrode film 109 and the electroformed film 112 and the laminated film of the insulating film 106 and the wiring electrode 103 in the exactly opposite directions are applied to the laminated films. Therefore, if total thicknesses and Young's moduli of the laminated film of the electrode film 109 and the electroformed film 112 and the laminated film of the insulating film 106 and the wiring electrode 103 are the same, even if a voltage is applied to the actuator 102, since the forces for deforming the laminated film of the electrode film 109 and the electroformed film 112 and the laminated film of the insulated film 106 and the wiring electrode 103 in the exactly opposite directions by the same amount are applied to the laminated films, the nozzle plate 100 is not deformed. Therefore, the ink is not ejected.

In this embodiment, the Young's modulus of the laminated film of the insulating film 106 and the wiring electrode 103 is smaller than the Young's modulus of the laminated film of the electrode film 109 and the electroformed film 112. Therefore, if the total thicknesses of the laminated films are the same, a deformation amount of the laminated film of the insulating film 106 and the wiring electrode 103 is larger with respect to the same force.

In the structure of this embodiment, if the actuator 102 expands in the direction orthogonal to the electric field direction, the nozzle plate 100 is deformed to the ink pressure chamber 201 side in a convex shape and the volume of the pressure chamber 201 is reduced (because an amount of deformation of the laminated film of the insulating film 106 and the wiring electrode 103 to the ink pressure chamber 201 side in a convex shape is larger). Conversely, if the actuator 102 contracts in the direction orthogonal to the electric field direction, the nozzle plate 100 is deformed to the ink pressure chamber 201 side in a concave shape and the volume of the pressure chamber 201 is increased (because an amount of deformation of the laminated film of the insulating film 106 and the wiring electrode 103 to the ink pressure chamber 201 side in a concave shape is larger). As a difference between the Young's modulus of the laminated film of the electrode film 109 and the electroformed film 112 and the Young's modulus of the laminated film of the insulating film 106 and the wiring electrode 103 is larger, when the same voltage is applied to the actuator 102, a difference between deformation amounts of oscillating plates increases. Therefore, ink ejection can be performed under a lower voltage condition if the difference between the Young's modulus of the laminated film of the electrode film 109 and the electroformed film 112 and the Young's modulus of the laminated film of the insulating film 106 and the wiring electrode 103 is larger.

As explained above, a deformation amount of the plate shape is affected by not only the Young's modulus of the plate material but also the thickness of the plate material. Therefore, if a deformation amount of the laminated film of the electrode film 109 and the electroformed film 112 and a deformation amount of the laminated film of the insulating film 106 and the wiring electrode 103 are set different, it is necessary to take into account not only Young's moduli of materials but also thicknesses of the laminated films. Even if the Young's modulus of the laminated film of the electrode film 109 and the electroformed film 112 and the Young's modulus of the laminated film of the insulating film 106 and the wiring electrode 103 are the same, if the thicknesses are different, ink ejection is possible, although under a high-voltage condition.

In this embodiment, whereas the total thickness of the laminated film of the electrode film 109 and the electroformed film 112 is 50.5 μm, the total thickness of the laminated film of the insulating film 106 and the wiring electrode 103 is 1 μm. Therefore, the total thickness of the laminated film of the electrode film 109 and the electroformed film 112 is set to be fifty or more times as larger as the total thickness of the laminated film of the insulating film 106 and the wiring electrode 103 such that the nozzle plate 100 can be deformed under a low-voltage condition.

After the formation of the electroformed film 112, when the resist pattern 111 is removed by a solution, a shape shown in FIG. 51 is obtained. When the resist pattern 111 is removed, the nozzle 101 having a circular truncated cone shape can be formed in the nozzle plate 100. In the nozzle plate 100, after the ink pressure chamber structure 200 and the ink supply path structure 400 are attached, the quartz substrate 105 can be removed by being ground or polished from a surface on the opposite side of a surface on which the electrodes and the like are formed.

In the nozzle plate 100 after the removal of the quartz substrate 105, the electroformed film 112 (having thickness of 50 μm) and the electrode film 109 form a base. The nozzle plate 100 has the piezoelectric film 107, the wiring electrode 103, and the insulating film 106 on the base. The electroformed film 112 and the electrode film 109 function as the electrode of the actuator 102.

In the above explanation, as the etching method, a wet etching method in which a chemical can be used and a dry etching method in which plasma can be used are selected as appropriate. Fabrication is performed with the etching method and etching conditions changed according to materials of the insulating film, the electrode film, the piezoelectric film, and the like. After the etching by the photo resist films ends, the remaining photo resist films are removed by a solution.

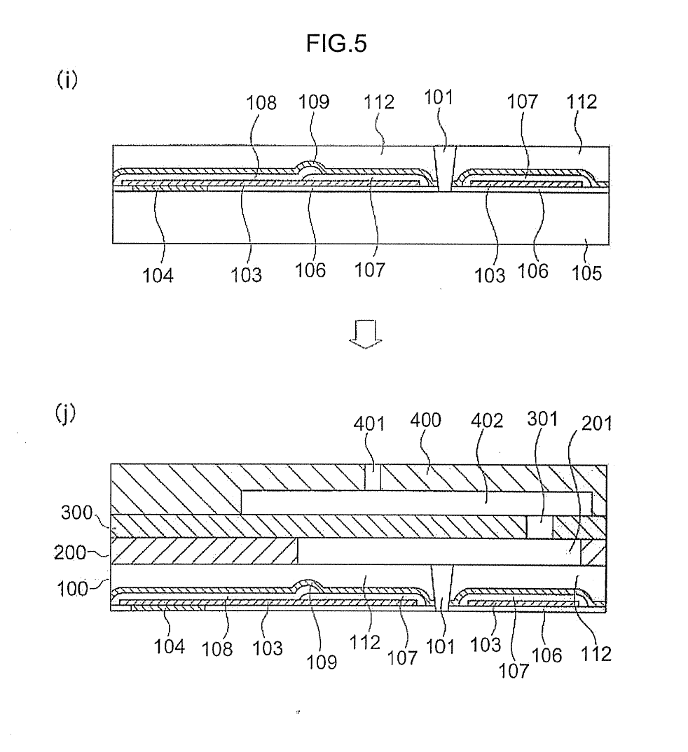

A section of the completed inkjet head 1 is shown in FIG. 5J. The ink pressure chamber structure 200 and the ink supply path structure 400 are bonded to the nozzle plate 100 fabricated in the process explained above to manufacture the inkjet head 1.

The ink is supplied from the ink supply port 401 provided in the ink supply path structure 400 to the ink supply path 402. The ink in the ink supply path 402 flows to the ink pressure chambers 201 and fills the nozzles 101. The ink supplied from the ink supply port 401 is kept at appropriate negative pressure. The ink in the nozzles 101 is kept without leaking from the nozzles 101.

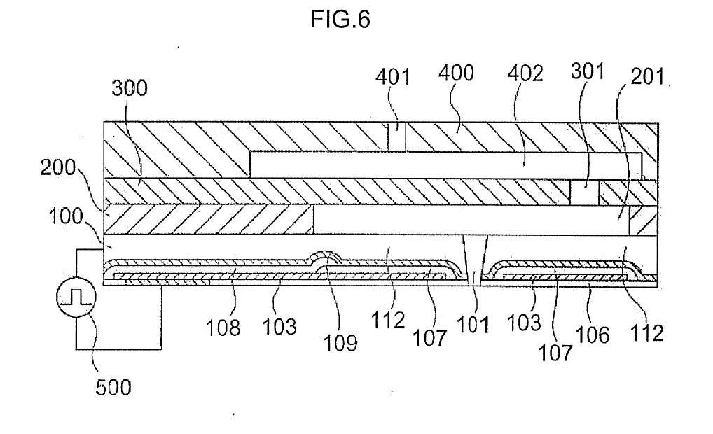

In FIG. 6, a configuration in which a driving circuit 500 is connected to the inkjet head 1 is shown. A driving signal generated by the driving circuit 500 causes the piezoelectric film 107 to operate between the individual electrode (the actuator wiring electrode 102a formed at an end of the wiring electrode 103 connected to the electrode terminal 104) and the electrode. The piezoelectric film 107 expands in a longitudinal direction of the film with an electric field generated between the individual electrode and the electrode. If the piezoelectric film 107 expands, the nozzle plate 100 bends in the forming section of piezoelectric film 107 in the nozzle plate 100 to reduce the volume of the ink pressure chamber 201. If the piezoelectric film 107 contracts, the nozzle plate 100 bends in the forming section of the piezoelectric film 107 in the nozzle plate 100 to increase the volume of the ink pressure chamber 201. This bending phenomenon is controlled to eject the ink from the nozzle 101.

The surface of the inkjet head 1 excluding the electrode terminal 104 is covered with the insulating film 106. Therefore, the inkjet head 1 can eject water based ink and solvent ink.

### Second Embodiment

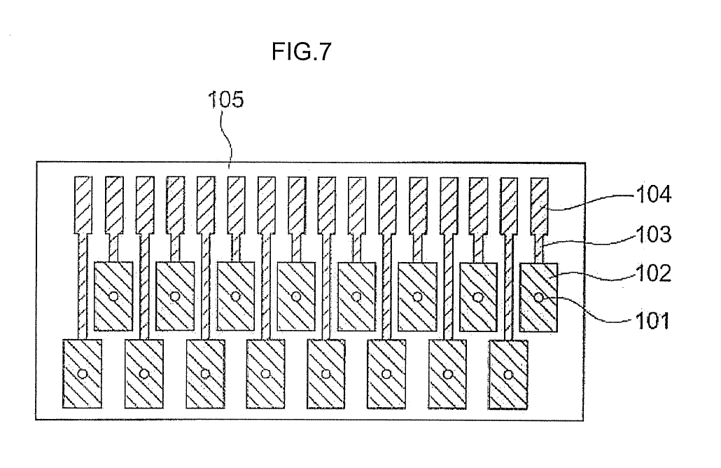

The inkjet head 1 according to a second embodiment is shown in FIG. 7. The shape of the piezoelectric film 107 is different from that in the first embodiment. The other components are the same as those in the first embodiment.

The piezoelectric film 107 can be formed in a rectangular shape having width of 3 mm and length of 6 mm. The diameter of the nozzle 101 on the ink ejection side can be set to 30 μm and the diameter of the nozzle 101 on the side for supplying ink to the nozzle 101 can be set to 50 μm. The shape of the ink pressure chamber 201 can be also a rectangular shape according to the shape of the piezoelectric film 107.

Compared with the circular piezoelectric film pattern, since the piezoelectric film 107 can be as large as 6 mm in the length direction, an actuator configured to eject the ink is long. Therefore, it is possible to increase ink ejection pressure.

### Third Embodiment

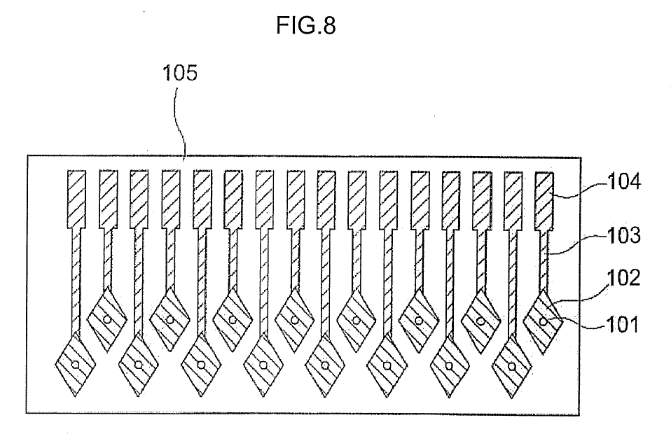

The inkjet head 1 according to a third embodiment is shown in FIG. 8. The shape of the piezoelectric film 107 is different from that in the first embodiment. The other components are the same as those in the first embodiment.

The piezoelectric film 107 can be formed in a rhomboid shape having width of 3 mm and length of 6 mm. The diameter of the nozzle 101 on the ink ejection side can be set to 30 μm and the diameter of the nozzle 101 on the side for supplying ink to the nozzle 101 can be set to 50 μm. The shape of the ink pressure chamber 201 can be also a rhomboid shape according to the shape of the piezoelectric film 107.

Compared with the circular piezoelectric film pattern, it is possible to arrange a piezoelectric pattern at higher density.

With respect to any figure or numerical range for a given characteristic, a figure or a parameter from one range may be combined with another figure or a parameter from a different range for the same characteristic to generate a numerical range.

Other than where otherwise indicated, all numbers, values and/or expressions referring to sizes, shapes, ingredients, distances, etc., used in the specification and claims are to be understood as modified in all instances by the term “about.”

The several embodiments of the present invention are explained above. However, these embodiments are presented as examples and are not intended to limit the scope of the invention. These new embodiments can be carried out in other various forms. Various kinds of omission, replacement, and change can be performed without departing from the spirit of the invention. These embodiments and modifications thereof are included in the scope and the spirit of the invention and include in the inventions described in claims and a scope of equivalents of the inventions.

What is claimed is:

1. An inkjet head comprising:
a nozzle plate in which a nozzle having an ejection hole for ink;
an ink supply path for supplying the ink to the nozzle;
a first electrode formed to surround the ejection hole of the nozzle of the nozzle plate;
a piezoelectric film configured to at least partially surround the ejection hole of the nozzle of the nozzle plate and cover the first electrode; and
a second electrode configured to cover the piezoelectric film and made of a metal material.

2. The inkjet head according to claim 1, wherein
a plurality of the nozzles are formed in the nozzle plate, and
the first electrode comprises individual electrode each configured to at least partially surround provided each of the nozzles.

3. The inkjet head according to claim 2, wherein the first electrode comprises:
a plurality of electrode terminals to which a driving signal is supplied from an outside of the ink jet head;
a plurality of wiring electrodes connected to the plurality of electrode terminals; and
a plurality of actuator wiring electrodes formed at ends of the plurality of wiring electrodes and configured to cover the piezoelectric film.

4. The inkjet head according to claim 1, wherein an insulating film is formed between the first electrode and the second electrode where the piezoelectric film is not covered.

5. The inkjet head according to claim 1, wherein
the inkjet head includes a plurality of the nozzles, and
the second electrode is a electrode provided to eject the ink from each of the nozzles.

6. The inkjet head according to claim 5, wherein the second electrode comprises:
an electrode film configured to cover at least the piezoelectric film; and
a metal material configured to cover the electrode film excluding the ejection hole and the metal material forms the nozzle plate.

7. The inkjet head according to claim 6, wherein the second electrode comprises an electrode of a laminated body.

8. The inkjet head according to claim 1, further comprising an insulating film configured to at least partially surround the nozzle and set in contact with the first electrode and the second electrode on a surface on an opposite side of the piezoelectric film.

9. The inkjet head according to claim 8, wherein a Young's modulus of the insulating film set in contact with the first electrode and the second electrode and a Young's modulus of the metal material of the second electrode are different.

10. An inkjet head comprising:
a nozzle plate in which a plurality of nozzles having ejection holes for ink;
an ink supply path for supplying the ink to the plurality of nozzles;
a first electrode formed to at least partially surround the ejection hole of each of the nozzles of the nozzle plate;
a piezoelectric film configured to at least partially surround the ejection hole of each of the nozzles of the nozzle plate and cover the first electrode; and
a second electrode configured to cover the piezoelectric film and made of a metal material, the metal material forming the nozzle plate.

11. A method of manufacturing an inkjet head comprising:
forming an insulating film on a substrate;
forming a first electrode film on the insulating film and fabricating the first electrode film into a predetermined shape;
forming a piezoelectric film of a predetermined shape to at least partially cover the first electrode;
forming a second electrode film of a predetermined shape to at least partially cover the piezoelectric film and the insulating film;
forming an ejection hole in the second electrode film and the insulating film;
forming a mask pattern in the ejection hole;
forming, on the second electrode film, with an electroforming method, an electrode forming a nozzle plate on an ink supply side; and
removing the mask pattern.

12. A method of ejecting ink from an inkjet head, comprising:
sending a driving signal to an electrode whereby the electrode causes a deformation in a piezoelectric film at least partially surrounding a nozzle, the deformed piezoelectric film facilitating an ejection of ink from the nozzle.

13. The method of claim 12, wherein a deformation in the piezoelectric film causes a pressure change in an ink chamber facilitating the ejection of ink from the nozzle.
